(19) United States
(12) Patent Application Publication
(10) Pub. No.: US 2013/0316121 A1
(43) Pub. Date: Nov. 28, 2013

(54) METHOD FOR MANUFACTURING AN INNER COVERING ASSEMBLY ON A MEMBER OF A FORMING TOOL

(71) Applicants: Godefroy Beau, La Garenne Colombes (FR); Jean François Oeuvrard, Pontoise (FR)

(72) Inventors: Godefroy Beau, La Garenne Colombes (FR); Jean François Oeuvrard, Pontoise (FR)

(73) Assignee: FAURECIA INTERIEUR INDUSTRIE, Nanterre (FR)

(21) Appl. No.: 13/574,002

(22) PCT Filed: Jan. 20, 2011
(86) PCT No.: PCT/FR11/50098

§ 371 Date: Jun. 29, 2013

(30) Foreign Application Priority Data
Jan. 20, 2010 (FR) 10 50367

(51) Int. Cl. B62D 65/02

(52) U.S. Cl. CPC B62D 65/02
USPC 428/68; 156/60; 156/219; 156/196

(57) ABSTRACT

A method for manufacturing an inner covering assembly (2) with multiple components for a vehicle, comprising a first component (4) and at least one second component (6), the said method comprising:
providing the components (4, 6) of the inner covering assembly;
an operation to attach the first component (4) to a member (26) of a forming tool (24) of the inner covering assembly;
inserting at least one second component (6) of the inner covering assembly into the forming tool (24); and
an operation for securing by adhering the first and second components (4, 6) of the inner covering assembly by activating the forming tool in order to obtain the inner covering assembly (2) having multiple components.

The present invention relates to a method for manufacturing a component of an inner covering assembly for a vehicle. More particularly the invention relates to [preamble of claim 1].

Said attaching method is known from FR 2 900 862 A1. In this known solution an element of a skin having multiple components is attached inside a forming tool under a vacuum effect derived from the forming tool. Nevertheless, this attaching solution is insufficient. The localised vacuum attaching the skin element must be achieved with a perfect seal, which is often difficult to obtain in particular in the presence of uneven surfaces. The slightest leak may cancel the attaching effect. In addition, provision must be made on the forming tool for a portion dedicated to receiving the skin element and provided with a vacuum device which, as early as the design stage of the forming tool, limits the positioning and geometry of the skin element. Also, if the surfaces are angled at more than 30°, in particular during the pressing step by the insert, the holding force applied by the vacuum is insufficient to retain the skin element in position.

It is therefore one objective of the invention to improve the attaching and holding of an inner covering assembly on a member of a forming tool.

According to the present invention, this objective is achieved with a manufacturing method of the afore-mentioned type characterized in that [characterizing part of claim 1].

By using an adhesive to attach the component of the inner covering assembly onto the member of the forming tool, better control is obtained over the adhering force of the component on the member. This particularly allows the component to be positioned in more angled parts of the member. In addition, the use of an adhesive allows variations in the shape of the component and its position on the member of the forming tool, the adhesive used being able to be adapted to the geometric shape of the component, and the component being then able to be applied against various portions of the member of the forming tool. It will be noted that the adhesion forces of this adhesive must be determined taking into account the bonding force between the first and second component. The gluing together of the first and second components in theory dissuaded persons skilled in the art from attaching the first component onto the member of the tool using an adhesive, on account of the difficulty to adjust the different bonding forces and the risks of undue detachment when the covering assembly is released from the tool. This is all the more the case with regard to thermoforming methods whereby the components are subjected to high temperatures which may substantially modify the adhesion forces.

Depending on particular embodiments of the invention, the attachment method comprises one or more of the following characteristics taken alone or in any possible technical combination:

### DEPENDENT CLAIMS

The invention will be more readily understood upon reading the following description given solely as an example and with reference to the Figures in which:

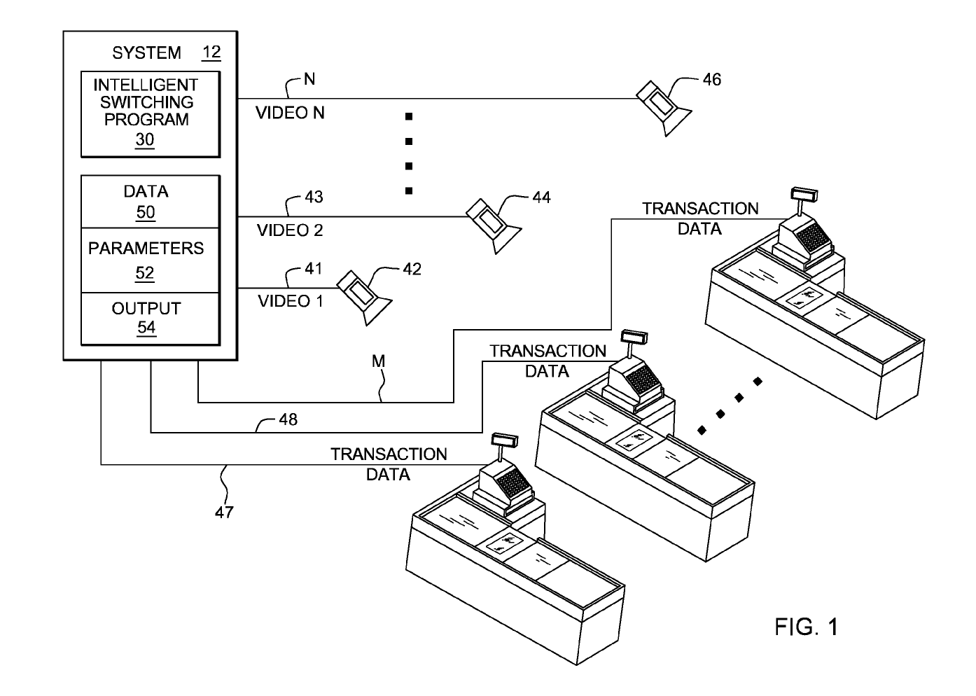

FIG. 1 is a cross-sectional view of an inner covering assembly having multiple components according to the invention;

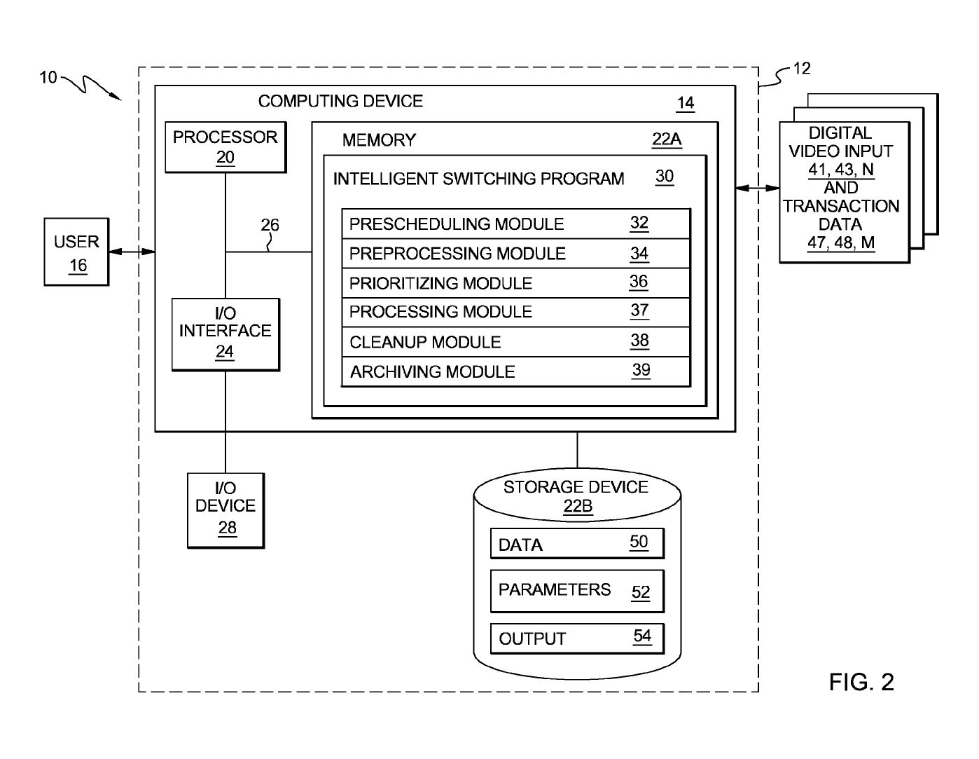

FIG. 2 is a cross-sectional view of a forming tool according to the invention;

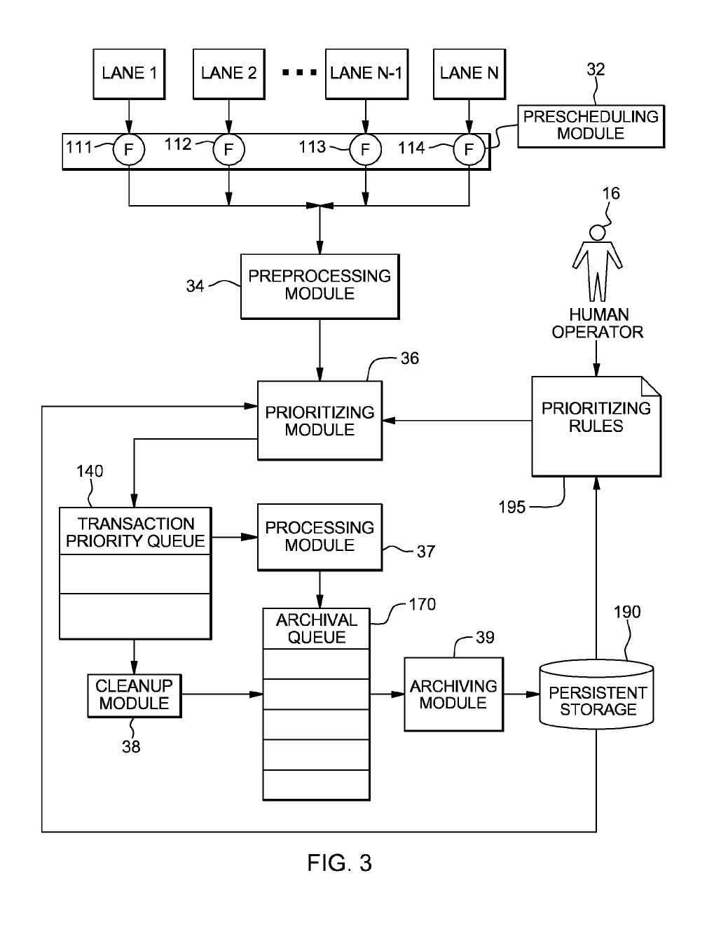

FIG. 3 shows the step of the invention in which the inner covering assembly component is coated with an adhesive in view of attaching thereof onto a member of the forming tool; and

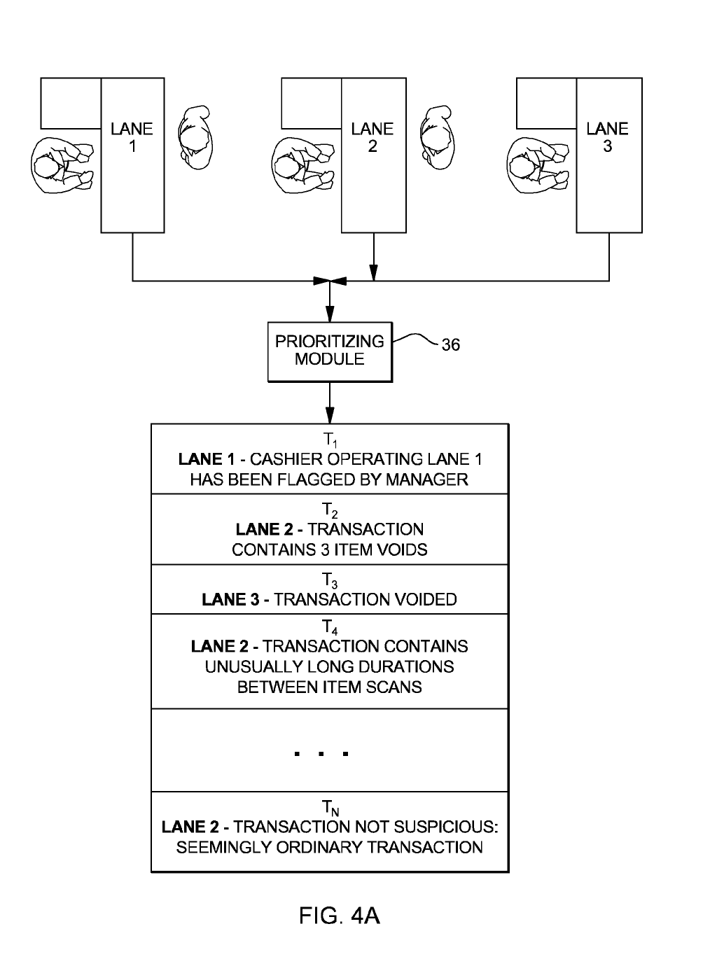

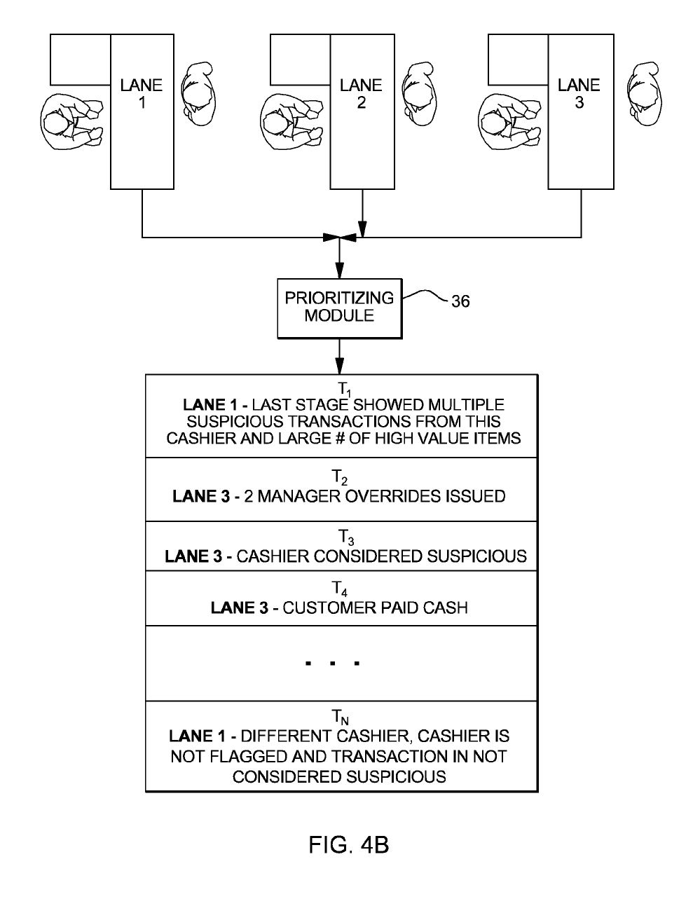

FIGS. 4 to 6 illustrate the manufacture according to the invention of the inner covering assembly with multiple components using the forming tool.

FIG. 1 gives a cross-sectional view of an inner covering assembly 2 having multiple components for a motor vehicle. The inner covering assembly 2 may be used in particular as covering for the dashboard of a motor vehicle.

The shape of the cross-section of the inner covering assembly 2 generally corresponds to the shape of a hat with a central projection 14 bordered on each side by a straight section 16.

The inner covering assembly 2 here comprises three components, namely a first component formed of a decorative element 4, a second component formed of a complex sheet 6 and a third component forming an insert 8. Evidently, the covering assembly could only comprise the two first components 4, 6. Preferably, the decorative element 4 is a thin board in particular having a thickness of about 400 micrometres, made in polycarbonate. The decorative element 4 has a first apparent surface 20 which is intended to be visible in the assembled state of the inner covering assembly 2, and a second connecting surface 22 ensuring the connection with the complex sheet 6. The complex sheet 6 comprises a film 10 preferably in polyphenylene oxide (PPO) or in thermoplastic olefin (TPO), and foam 12 preferably in polypropylene (PP) joined to the film 10. The insert 8 is preferably in polypropylene (PP) and imparts the necessary rigidity to the inner covering assembly 2.

The decorative element 4 and the insert 8 are embedded in the complex sheet 6. The decorative element 4 is positioned on an outer surface 18 of the projection 14. The apparent surface 20 of the decorative element 4 forms parts of the outer surface 18 of the projection 14. The insert 8 is located on the inner side of the projection 14 opposite the decorative element 4.

FIG. 2 shows a cross-section of the forming tool 24 according to the invention which is used to manufacture the inner covering assembly 2 shown in FIG. 1. The forming tool 24 comprises two members, namely a concave mould 26 and a punch 28. The mould 26 and the punch 28 have mating shapes. The mould 26 comprises a central cavity 30 capable of receiving a central projection 32 of the punch 28. The forming tool 24 is a vacuum forming tool. One forming surface 34 of the cavity 30 of the mould 26 has a grained surface.

A description will now be given of the method according to the invention for manufacturing the inner covering assembly 2 having multiple components with reference to FIGS. 3 to 6 which typically illustrate a thermoforming method.

First a sheet of polycarbonate is provided to form the decorative element 4. Said sheets are supplied with a protective film 36 (cf. FIG. 3) to protect the surface of the sheet. The protective film 36 is a peel-off film i.e. it can be removed from the surface of the polycarbonate sheet.

Next, an adhesive 44 is applied to the protective film 36 of the polycarbonate sheet. As a variant, the protective film 36 can be removed from the polycarbonate sheet before applying the adhesive 44.

Preferably, the adhesive 44 is in the form of a double-sided adhesive film with a first adhesive side 46 and a second adhesive side 48. This type of double-sided adhesive film is supplied in roll form, the first adhesive side 46 being covered with a peel-off intermediate film 50. A section of the double-sided adhesive film 44 is taken from the roll and a piece of adhesive film 44 having a shape corresponding to the shape of the polycarbonate sheet is cut out. The piece of adhesive film 44 is applied via its second adhesive side 48 onto the protective film 36 of the polycarbonate sheet. If the protective film 36 has already been removed, the second adhesive side 48 is applied directly onto the apparent surface 20 of the polycarbonate sheet.

The use of a double-sided adhesive 44 offers wide possibilities for adjusting the adhesion forces of each of the sides 46, 48 of the film. However, the use of the double sided film 44 or of any inter-positioned film such as the protective film 36 imparts an advantageous characteristic to the finished covering assembly 2. The extra thickness afforded by the film 36 positions the apparent surface 20 of the decorative element 4 in slightly recessed manner relative to the outer surface of the second component 6. As a result, the risk of the decorative element 4 becoming detached from the finished covering assembly 2 is reduced as compared to the case in which it lies perfectly flush.

With respect to the adhesion force of the adhesive 44 on the surface 34 of the forming member 26, it is to be noted that the presence of the grained reliefs has the effect of reducing this force. In addition, this same forming member 26 can be used to manufacture an inner covering assembly not comprising the first component 4 making it possible to obtain savings in production costs.

Preferably, the adhesive 44 resists heat at least up to a temperature of about 100° C., i.e. the adhesive maintains its adhesive properties up to this temperature.

Next, or beforehand, heat-activated glue 38 is deposited on the connecting surface 22 of the polycarbonate sheet. The heat-activated glue 38 preferably has a fairly high activation temperature, in particular from 45° C. to 90° C. However, the activation temperature is advantageously chosen to be lower than the heat-resistance temperature of the adhesive 44.

The decorative element 4 is then cut out of the polycarbonate sheet as per the desired geometry.

It can be envisaged to deposit the adhesive 44 so that it only covers part of the apparent surface 20 of the decorative element 4. Nevertheless, it is preferable that the adhesive 44 covers the entirety of apparent surface 20 to ensure good securing of the decorative element 4 over its entire surface and thereby avoid marking or deformation of the decorative element 4 during the manufacture of the inner covering assembly 2, at the areas of the apparent surface 20 that are not coated with adhesive 44.

FIG. 3 shows a decorative element 4 once cut out, with the heat-activated glue 38 spread over the connecting surface 22 and the adhesive 44 covering the apparent surface 20. Preferably, the thickness of the intermediate film 50 is about 100 micrometres, the thickness of the double-sided adhesive film 44 about 100 micrometres, the thickness of the protective film 36 between 50 and 500 micrometres depending on the desired offset, the thickness of the decorative element 4 about 400 micrometres and the thickness of the heat-activated glue layer 38 about 50 micrometres.

The intermediate film 50 is then removed from the adhesive film 44 to expose the first adhesive surface 46. The assembly of layers 37 formed by the decorative element 4 provided with glue 38, the protective film 36 and adhesive 44 is then attached to the mould 26 of the forming tool 24 such as illustrated in FIG. 4. More precisely, the apparent surface 20 coated with the adhesive 44 of the decorative element 4 is applied against the forming surface 34 of the cavity 30 of the mould 26.

The complex sheet 6 and the insert 8 are then inserted in the forming tool 24, the complex sheet 6 being held between the mould 26 and the punch 28, the insert 8 being placed on the projection 32 of the punch 28. The complex sheet 6 is previously heated, preferably by infrared radiation, to a temperature which may be between 160° C. and 240° C. depending on the type of sheet. This leads to the state illustrated in FIG. 4.

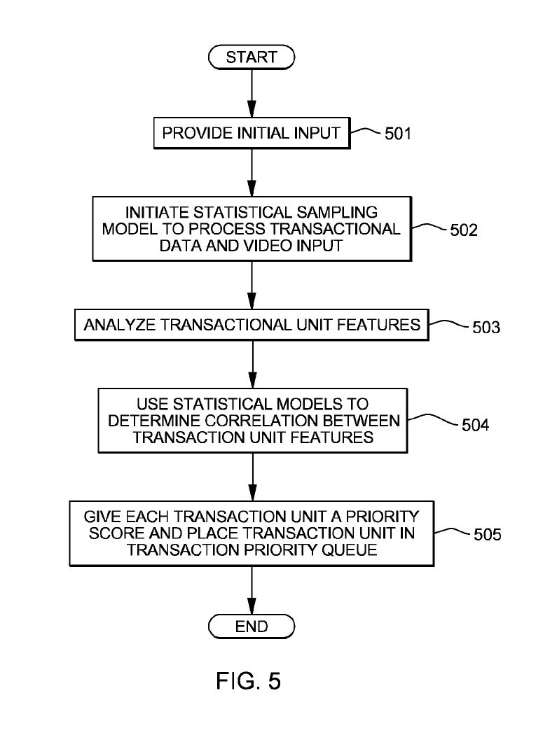

The next step consists in activating the forming tool 24. The mould 26 and punch 28 are brought close to each other to deform the complex sheet 6 around the projection 32 of the punch 28 so that the complex sheet 6 follows the contour of the projection 32. At the same time, the assembly of layers 37 is pressed into the complex sheet 6. Through the heat input by the hot complex sheet 6, the glue 38 is activated and the decorative element 4 becomes glued to the complex sheet 6. At the same time, a vacuum is applied in the residual space 52 between the mould 26 and the complex sheet 6. The complex sheet 6 is thereby aspirated towards the forming surface 34 of the mould 26. In this manner graining of the surface of the complex sheet 6 is obtained. This leads to the state illustrated in FIG. 5.

The concave mould 26 is preferably adjusted to a relatively high temperature, from 60° to 90° C., i.e. a temperature lower than the heat-resistance temperature of the adhesive 44 and close to the activation temperature of the glue 38. The punch 28 is set at a more usual temperature, for example of the order of 40° C.

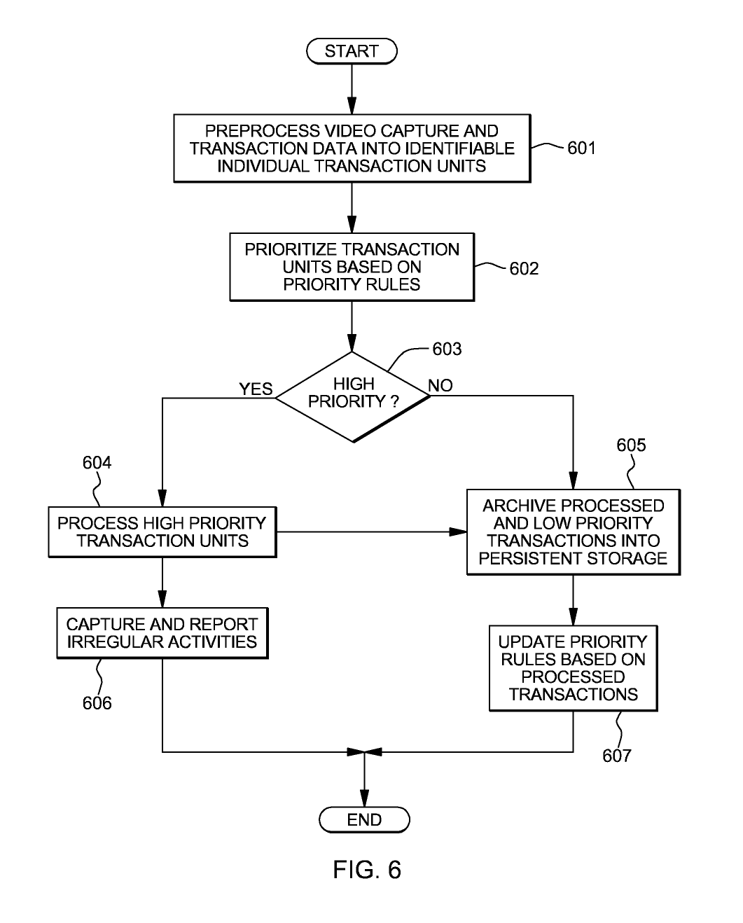

Finally, the vacuum in the space 52 is lifted and a vacuum is applied in the space 54 located between the complex sheet 6 and the projection 32 of the punch 28. The complex sheet 6 is thereby aspirated towards the surface of the projection 32 making it possible to glue the complex sheet 6 on and over the edges of the insert 8. This leads to the state illustrated in FIG. 6.

The manufacturing method being completed, the mould 26 and punch 28 are drawn away from each other to release the inner covering assembly 2. By so doing, the double-sided adhesive film 44 remains glued to the protective film 36 or to the apparent surface 20 of the decorative element 4, the double-sided adhesive film having been chosen to ensure an adhesion force between the adhesive film 44 and the protective film 36/apparent surface 20 that is greater than the adhesion force between the adhesive film 44 and the forming surface 34 of the cavity 30 of the mould 26. Finally, the inner covering assembly 2 is removed from the punch 28.

If the protective film 36 is present, it is detached from the decorative element 4 which has the effect at the same time of removing the double-sided adhesive film 44. If the protective film 36 is not present, the double-sided adhesive film is detached directly from the apparent surface 20.

By fixing the decorative element 4 on the mould 26 by means of an adhesive, it is possible to hold the decorative element 4 in place to within +/−0.5 mm throughout all the steps of the method for manufacturing the inner covering assembly 2, without any deformation or sliding or risk of damage either to the decorative element or to the mould.

In addition, by using adhesive to attach the decorative element, greater flexibility is obtained in the choice of shape of the decorative element and the positioning thereof in the mould.

Preferably, the adhesion force between the adhesive film and the surface 34 of the forming member is equal to or less than 5 N/cm.

Preferably, the adhesive 44 has a cross-linking rate of more than 90% to prevent fouling of the surface 34 of the forming member 26.

1. A method for manufacturing an inner covering assembly having multiple components for a vehicle, comprising a first component and at least one second component, the said method including:
providing the components of the inner covering assembly;
attaching the first component to a member of a forming tool of the inner covering assembly;
inserting the said at least one second component of the inner covering assembly into the forming tool; and
securing by adhering the first and second components of the inner covering assembly by activating the forming tool in order to obtain the inner covering assembly having multiple components,
characterized in that the step of attaching the first component to the member of the forming tool comprises the steps of:
coating with an adhesive the surface of the first component intended to lie opposite the forming member of the forming tool; and
applying the surface coated with adhesive of the first component against a surface of the forming member of the forming tool so as to obtain the attaching of the said first component to the member of the forming tool, via the adhesive, the adhesion force between the adhesive and the said surface of the forming member being lower than the adhesion force between the adhesive and the said surface of the first component and lower than the bonding force between the first component and the second component after the securing operation.

2. The method according to claim 1 wherein the adhesive is a double-sided adhesive film having a first adhesive side and a second adhesive side, the first adhesive side of the adhesive film ensuring the adhesion of the adhesive film, and hence of the component of the inner covering assembly, to the said surface of the forming member of the forming tool, and the second adhesive side of the adhesive film ensuring the adhesion of the adhesive film to the said surface of the component.

3. The method according to claim 2 wherein the double-sided adhesive film is chosen so as to ensure an adhesion force between the adhesive film and the said surface of the component that is greater than the adhesion force between the adhesive film and the said surface of the forming member of the forming tool.

4. The method according to claim 1 wherein the member of the forming tool has grained reliefs for graining the inner covering assembly, the said reliefs extending at least in part over the surface against which the surface coated with adhesive of the first component is applied.

5. The method according to claim 1 wherein the adhesion force between the adhesive film and the surface of the forming member is equal to or less than 5 N/cm.

6. The method according to claim 1 wherein the adhesive covers the entirety or almost the entirety of the said surface of the component and/or the adhesive only covers part of the forming surface which coincides with the surface of the component.

7. The method according to claim 1 wherein the adhesive has a heat-resistance temperature of about 100° C. or higher such that it resists heat at least up to a temperature of about 100° C.

8. The method according to claim 1 wherein the adhesive has a cross-linking rate of more than 90% to prevent fouling of the surface of the forming member.

9. The method according to claim 7 wherein a heat-activated glue is present on a connecting surface of the first component with the second component, the activation temperature of the heat-activated glue being lower than the heat-resistance temperature of the adhesive.

10. The method according to claim 1 further comprising a thermo-forming operation of the second component against the member of the forming tool, which comprises the steps of:
heating, the second component of the inner covering assembly,
compressing the said second component against the member, and
waiting for partial cooling of the second component.

11. The method according to claim 7 wherein the second component is heated during the heating step to a temperature significantly higher than the heat-resistance temperature of the adhesive.

12. The method according to claim 9 wherein the member of the forming tool is set at a temperature lower than the heat-resistance temperature of the adhesive and higher than the activation temperature of the heat-activated glue.

13. An inner covering assembly having multiple components for a vehicle, manufactured using the method of claim 1, wherein the outer surface of the first component is arranged slightly recessed relative to the outer surface of the second component by which it is surrounded.
